(19) United States
(12) Patent Application Publication
(10) Pub. No.: US 2018/0056724 A1
(43) Pub. Date: Mar. 1, 2018

(54) REDUCED WEIGHT AIRCRAFT TIRE

(71) Applicant: The Goodyear Tire & Rubber Company, Akron, OH (US)

(72) Inventors: Frank Anthony KMIECIK, Akron, OH (US); John Joseph SLIVKA, Danville, VA (US)

(21) Appl. No.: 15/672,342

(22) Filed: Aug. 9, 2017

Related U.S. Application Data
(60) Provisional application No. 62/381,604, filed on Aug. 31, 2016.

(51) Int. Cl. B60C 9/28; B60C 1/00; B60C 9/00; B60C 9/20

(52) U.S. Cl. CPC B60C 9/28; B60C 1/0008; B60C 2200/02; B60C 9/20; B60C 9/0057

(57) ABSTRACT

A pneumatic tire having a carcass and a belt reinforcing structure, the belt reinforcing structure comprising: a zigzag belt reinforcing structure formed of a strip of one or more reinforcement cords, the strip of one or more reinforcement cords being inclined at 5 to 30 degrees relative to the centerplane of the tire extending in alternation to turnaround points at each lateral edge, wherein the zigzag strip of cords may be formed from two different reinforcement cords made of different materials, and the lateral edges of the strip are preferably pointed or triangular in shape.

### FIELD OF THE INVENTION

This invention relates to pneumatic tires having a carcass and a belt reinforcing structure, more particularly to high speed heavy load tires such as those used on aircraft.

### BACKGROUND OF THE INVENTION

Pneumatic tires for high speed applications experience a high degree of flexure in the crown area of the tire as the tire enters and leaves the area of the footprint. This problem is particularly exacerbated on aircraft tires wherein the tires can reach speed of over 200 mph at takeoff and landing.

When a tire spins at very high speeds the crown area tends to grow in dimension due to the high angular accelerations and velocity, tending to pull the tread area radially outwardly. Counteracting these forces is the load of the vehicle which is only supported in the small area of the tire known as the footprint area.

Current tire design drivers are an aircraft tire capable of high speed, high load and with reduced weight. It is known in the prior art to use zigzag belt layers in aircraft tires, such as disclosed in the Watanabe U.S. Pat. No. 5,427,167. Zigzag belt layers have the advantage of eliminating cut belt edges at the outer lateral edge of the belt package. The inherent flexibility of the zigzag belt layers also help improve cornering forces. However, a tire designed with zigzag belt layers may result in too many layers at the belt edges which may reduce durability. Further, there is generally a tradeoff between load capacity and weight. Thus an improved aircraft tire is needed, which is capable of meeting high speed, high load and with reduced weight.

### Definitions

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Cord” means one of the reinforcement strands of which the plies in the tire are comprised.

“Equatorial plane (EP)” means the plane perpendicular to the tire's axis of rotation and passing through the center of its tread.

“Modulus of elasticity” of a cord at a given strain or stress means the extension secant modulus calculated at the given strain or stress. A high elastic modulus means a secant elastic modulus over 1000 cN/tex and a low elastic modulus means a secant modulus under 600 cN/tex.

“Ply” means a continuous layer of rubber-coated parallel cords.

“Radial” and “radially” mean directions radially toward or away from the axis of rotation of the tire.

“Radial-ply tire” means a belted or circumferentially-restricted pneumatic tire in which the ply cords which extend from bead to bead are laid at cord angles between 65° and 90° with respect to the equatorial plane of the tire.

“Section width” is the distance between a tire's sidewalls measured at the widest part of the tire when inflated to rated pressure and not under load.

“Tangent modulus of elasticity” of a cord at a given strain or stress means the extension tangent modulus of the cord. At a given stress or strain, the tangent modulus of elasticity is the value of the slope of the tangent to the stress strain curve, and can be determined from ASTM E111-04, entitled “Standard Test Method for Young's Modulus, Tangent Modulus, and Chord Modulus.”

“Zigzag belt reinforcing structure” means at least two layers of cords or a ribbon of parallel cords having 1 to 20 cords in each ribbon and laid up in an alternating pattern extending at an angle between 5° and 30° between lateral edges of the belt layers.

### BRIEF DESCRIPTION OF THE DRAWINGS

FIG. 1 is a schematic cross-sectional view of a first embodiment of half of a tire according to the invention;

FIG. 2 is a schematic perspective view of a zigzag belt layer in the middle of the formation;

FIG. 3 is a first embodiment of a belt reinforcement strip;

FIG. 4 is a first embodiment of a zigzag belt layer formed from the reinforcement strip of FIG. 3;

FIG. 5 is a schematically enlarged cross-sectional view of a first embodiment of half of a composite belt package for a tire showing the belt layer configuration;

### DETAILED DESCRIPTION OF THE INVENTION

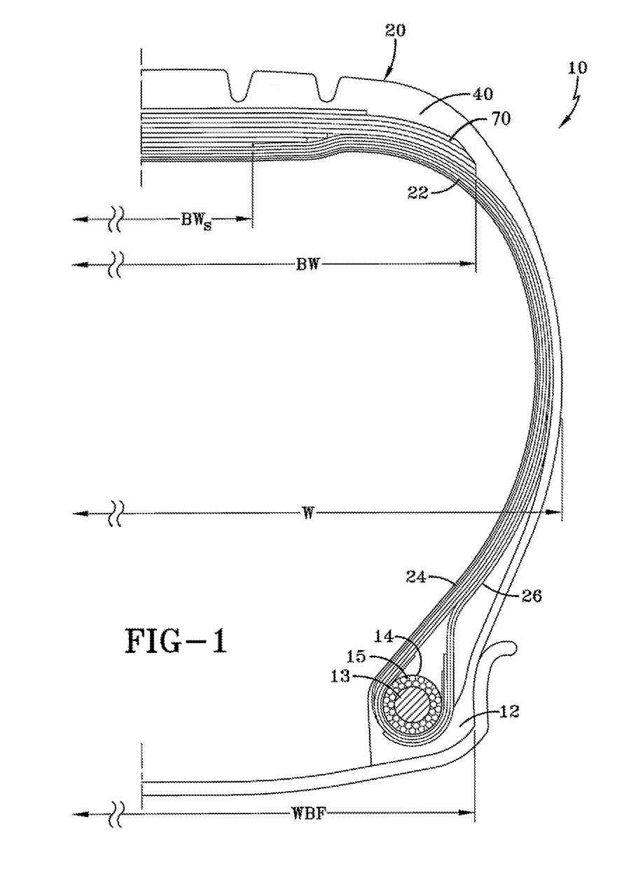

FIG. 1 illustrates a cross-sectional view of one half of a radial aircraft tire 10 of the present invention. The tire is symmetrical about the mid-circumferential plane so that only one half is illustrated. As shown, the aircraft tire comprises a pair of bead portions 12 each containing a bead core 14 embedded therein. One example of a bead core suitable for use in an aircraft tire is shown in U.S. Pat. No. 6,571,847. The bead core 14 preferably has an aluminum, aluminum alloy or other light weight alloy in the center portion 13 surrounded by a plurality of steel sheath wires 15. A person skilled in the art may appreciate that other bead cores may also be utilized.

The aircraft tire further comprises a sidewall portion 16 extending substantially outward from each of the bead portions 12 in the radial direction of the tire, and a tread portion 20 extending between the radially outer ends of the sidewall portions 16. The tire is shown mounted on a rim flange having a rim flange width extending from one bead to the other bead and indicated as WBF in FIG. 1. The section width of the tire is indicated in FIG. 1 as W and is the cross-sectional width of the tire at the widest part when inflated to normal pressure and not under load.

Furthermore, the tire 10 is reinforced with a carcass 22 toroidally extending from one of the bead portions 12 to the other bead portion 12. The carcass 22 is comprised of inner carcass plies 24 and outer carcass plies 26, preferably oriented in the radial direction. Among these carcass plies, typically four inner plies 24 are wound around the bead core 14 from inside of the tire toward outside thereof to form turnup portions, while typically two outer plies 26 are extended downward to the bead core 14 along the outside of the turnup portion of the inner carcass ply 24.

The aircraft may be an H type tire having a ratio of WBF/W in the range of about 0.65 to 0.7, and more preferably in the range of about 0.65 to about 0.68.

Each of these carcass plies 24,26 may comprise any suitable cord, typically nylon cords such as nylon-6,6 cords extending substantially perpendicular to an equatorial plane EP of the tire (i.e. extending in the radial direction of the tire). Preferably the nylon cords have an 1890 denier/2/2 or 1890 denier/3 construction. One or more of the carcass plies 24, 26 may also comprise an aramid and nylon cord structure, for example, a hybrid cord, a high energy cord or a merged cord. Examples of suitable cords are described in U.S. Pat. No. 4,893,665, U.S. Pat. No. 4,155,394 or U.S. Pat. No. 6,799,618. The ply cords may have a percent elongation at break greater than 8% and less than 30%, and more preferably greater than 9% and less than 28%.

### Belt Package

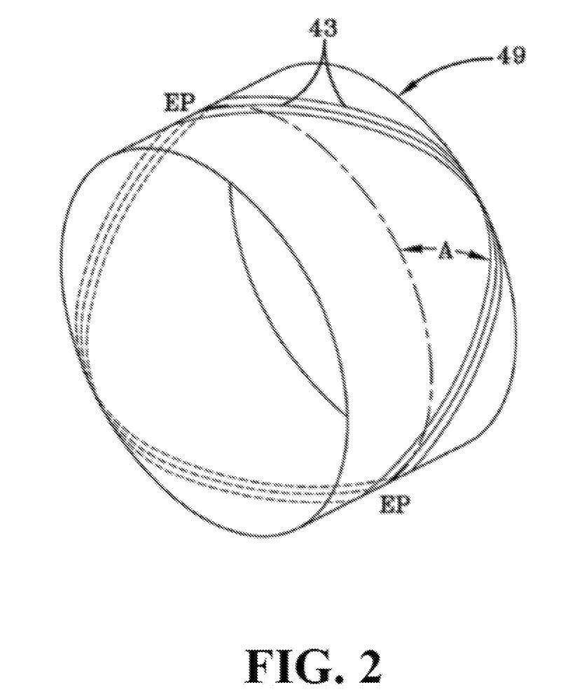

The aircraft tire 10 further comprises at least one zigzag belt reinforcing structure 70. As shown in FIG. 2, the zigzag belt structure of the invention is formed from a rubberized strip of cords 43 that is wound generally in the circumferential direction to extend between alternating lateral edges of a tire building drum 49 or core. The strip is wound along in zigzag path many times while the strip of cords 43 is shifted a desired amount in the axial direction so as not to form a gap between the adjoining strip of cords 43. As a result, the cords extend in the circumferential direction while changing the bending direction at a turnaround point at each lateral drum ends. The cords of the zigzag belt structure cross with each other, typically at a cord angle A of 5 degrees to 30 degrees with respect to the equatorial plane EP of the tire. Each zigzag belt structure typically has at least two layers of cord formed in the zigzag belt structure and has the advantage of no cut ends at the outer lateral ends of the belt structure.

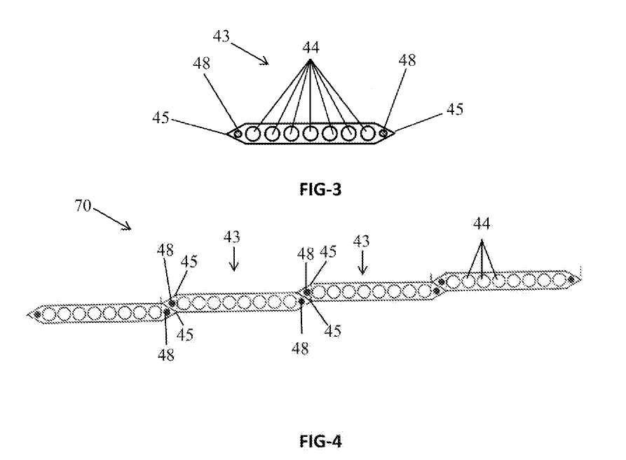

A composite strip of cords 43 of the present invention is shown in FIG. 3. The composite strip of cords 43 is formed of two or more parallel first reinforcement cords 44, wherein the first reinforcement cords 44 are the same material. The first reinforcement cords are embedded in rubber. The width of the strip may vary as desired, but it may range from about 0.25 inches to 1 inch, and more preferably in the range from about 0.3 inches to 0.6 inches (wherein the word “about” means a variation of +/−5%). As shown in FIG. 3, the lateral edges 45 of the strip of cords 43 are triangular in shape. Embedded in each lateral edge is a second reinforcement cord 48 that preferably has a smaller diameter cord than the first reinforcement cords. Thus, as shown in FIG. 4, as the composite strip of cords 43 is wound about the tire building drum 49, a lateral triangular edge 45 of a first composite strip of cords 43 may be stacked against a lateral triangular edge 45′ of the adjacent strip 43′ so that the second reinforcement cords 48 are radially stacked adjacent each other.

More preferably, the composite strip of cords 43 is formed of reinforcements made from different materials, so that the first reinforcement cords 44 are formed of a first material, and the second reinforcement cords 48 are formed of a second material, different than the first material. The first reinforcement cords 44 are located axially between the second reinforcement cords 48. Preferably, the first reinforcement cords 44 are formed of a material having a higher modulus than the second reinforcement cords 48. The first reinforcement cords 44 preferably are formed of a material having a tangent modulus at 80% break greater than 4500 MPA, and more preferably in the range of 10,000 MPA to 31,000 MPA.

The first reinforcement cords 44 may be formed of any higher modulus material such as aramid, POK or a merged or hybrid cord made of aramid and nylon. One example of a suitable cord construction may comprise a composite of aramid and nylon, containing two cords of a polyamide (aramid) with construction of 3300 dtex with a 6.7 twist, and one nylon or nylon 6/6 cord having a construction of 1860 dtex, with a 4.5 twist. The overall merged cable twist is 6.7. A second example of a suitable high modulus cord construction contains three cords of a polyamide with a construction of 1670 denier/1/3 construction.

The second reinforcement cords 48 may be formed of any desired materials preferably having a tangent modulus at 80% break of less than 4500 MPA. It is preferred that the second reinforcement cords 48 be formed of Nylon or Nylon 6/6. It is more preferred that the second reinforcement cords 48 be made of Nylon having an 840/2 denier construction or other cord construction having a smaller diameter than the first reinforcement cords 44.

In the example shown in FIG. 3, there are 9 total reinforcement cords arranged in parallel relationship to each other. The composite strip 43 preferably has a 0.55 inch width. There are 7 first reinforcement cords 44 have an EPI (ends/inch) of 16, but are not limited to same. The first reinforcement cords 44 are preferably made of a merged cord of nylon and aramid or aramid. Preferably, the composite strip 43 has a nylon reinforcement cord 48 located on each lateral edge of the strip having an 840/2 denier construction. Thus the nylon reinforcement cord 48 is smaller in diameter than the first reinforcement cords. As shown in FIG. 3, the lateral edge of each strip has a triangular shaped or pointed edge.

### Belt Package

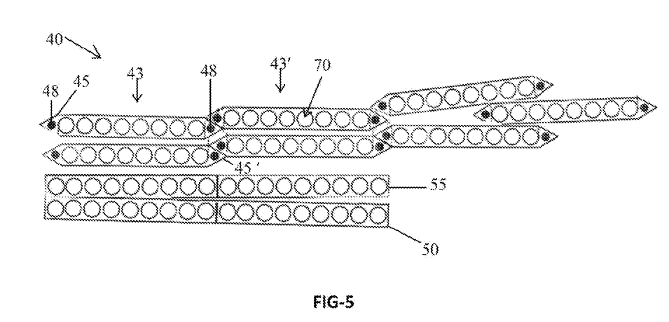

One half of a symmetrical belt package 40 for a tire of the present invention is shown in FIG. 5. The belt package 40 includes a first zigzag belt structure 70 formed from a composite strip 43 of the present invention. The zigzag belt structure 70 illustrates that a lateral triangular end 45′ of a first composite strip 43′ is stacked in mating engagement with the nearest lateral triangular end 45 of the adjacent strip 43. An optional low angle belt 50 is located radially inward of the zigzag belt 70. The low angle belt 50 is preferably formed of reinforcement cords forming an angle of 10 degrees or less with respect to the mid-circumferential plane, and more preferably, 5 degrees or less. Preferably, the first belt layer 50 is formed of a first rubberized strip 41 of two or more cords made by spirally or helically winding the cords relative to the circumferential direction. The first belt layer 50 is the narrowest belt structure of the belt package 40, and has a width in the range of about 13% to about 100% of the rim width (width between flanges).

The belt package 40 may further optionally comprises a second belt layer 55 located radially outward of the first belt layer 50. The second belt layer 55 is preferably formed of cords having an angle of 10 degrees or less with respect to the mid-circumferential plane. Preferably, the second belt layer 55 is formed of a rubberized strip 41 of two or more cords made by spirally or helically winding the cords relative to the circumferential direction. The second belt layer has a width in the range of about 13% to about 100% of the rim width. Preferably the second belt layer 55 has a width the same or slightly greater than the first belt layer 50.

It is additionally preferred that the ply cords have a greater elongation at break than the belt cords elongation at break. The cord properties such as percent elongation at break, linear density and tensile strength are determined from cord samples taken after being dipped but prior to vulcanization of the tire.

The above described invention improves the burst strength of the tire by increasing the ratio of merged cords to nylon cords. The use of nylon cords at the edges of the strips provide a durability advantage, because Nylon is very forgiving and is utilized where the strain is highest (at the edge of the strip). However, the use of nylon results in a trade off in burst strength. The invention overcomes this disadvantage by providing for nylon reinforcements at the strip edge for durability, while at the same time increasing the ratio of merged cords to nylon cords, which increase the tire's burst strength.

Variations of the present invention are possible in light of the description as provided herein. While certain representative embodiments and details have been shown for the purpose of illustrating the subject inventions, it will be apparent to those skilled in the art that various changes and modifications can be made without departing from the scope of the subject inventions.

What is claimed is:

1. A pneumatic tire comprising a carcass and a belt reinforcing structure, the belt reinforcing structure being formed by winding a strip of reinforcement cords, wherein the strip of reinforcement cords is formed from a plurality of first reinforcement cords and a second reinforcement cord located on each lateral end of the strip, wherein the strip of reinforcement cords has outer lateral ends that are triangular in shape.

2. The pneumatic tire of claim 1 wherein the first reinforcement cord is formed of a higher modulus material than the second reinforcement cord.

3. The pneumatic tire of claim 1 wherein the first reinforcement cord has a larger diameter than the second reinforcement cord.

4. The pneumatic tire of claim 1 wherein the first reinforcement cord has a tangent modulus at 80% of break greater than 5000 MPA.

5. The pneumatic tire of claim 1 wherein the second reinforcement cord has a tangent modulus at 80% of break less than 5000 MPA.

6. The pneumatic tire of claim 1 wherein the first reinforcement cord has a tangent modulus at 80% of break less than 35000 MPA.

7. The pneumatic tire of claim 1 wherein there are at least two second reinforcement cords in a strip, and each second reinforcement cord is located at each lateral end of the strip.

8. The pneumatic tire of claim 1 wherein the first reinforcement cord is formed of aramid and nylon filaments.

9. The pneumatic tire of claim 1 wherein the first reinforcement cord is formed of aramid filaments.

10. The pneumatic tire of claim 1 wherein the second reinforcement cord is formed of nylon filaments.

11. The pneumatic tire of claim 1 wherein the second reinforcement cord is formed of nylon filaments having an 840/2 denier.

12. The pneumatic tire of claim 1 wherein the strip has at least 9 reinforcement cords.

13. The pneumatic tire of claim 1 wherein the strip has a width of 0.5 inches.

14. The pneumatic tire of claim 1 wherein the strip has an epi of 16.

15. The pneumatic tire of claim 1 wherein the strip has an epi of 18.

16. The pneumatic tire of claim 1 wherein the belt is a zigzag belt.

17. The pneumatic tire of claim 1 wherein the belt is a helically wound belt.

18. A pneumatic tire comprising a carcass and a belt reinforcing structure, the belt reinforcing structure being formed by winding a strip of reinforcement cords, wherein the strip of reinforcement cords is formed from a plurality of first reinforcement cords and a second reinforcement cord located on each lateral end of the strip, wherein at least one of the first reinforcement cords has a larger diameter than the second reinforcement cord.

19. The pneumatic tire of claim 18 wherein the strip of reinforcement cords has outer lateral ends that are triangular in shape.

20. The pneumatic tire of claim 18 wherein the first reinforcement cord is formed of a higher modulus material than the second reinforcement cord.
